(19) United States
(12) Patent Application Publication
(10) Pub. No.: US 2002/0010821 A1
(43) Pub. Date: Jan. 24, 2002

(54) USB extension system

(76) Inventors: Gang Yu, Sunnyvale, CA (US); Chu-Ching Nei, Los Altos, CA (US)

Correspondence Address: GARY CARY WARE & FREIDENRICH, 1755 EMBARCADERO, PALO ALTO, CA, 94303-3340, US

(21) Appl. No.: 09/878,618

(22) Filed: Jun. 11, 2001

Related U.S. Application Data
(60) Provisional application No. 60/210,577, filed on Jun. 9, 2000.

(51) Int. Cl. G06F 13/00

(52) U.S. Cl. 710/100

(57) ABSTRACT

A USB extension system is disclosed which converts the standard USB signal into a low voltage differential signal and is installed between a USB hub or host and a USB device, and which drives the interconnecting cable with a true differential signal, i.e. a balanced signal, the problems with interference are greatly reduced. In accordance with the present invention, the standard USB signals are encoded into differential form using differential signals of different magnitudes. In one embodiment, differential signals of a “weak” magnitude are used to encode the “J” and the “K” states of the standard USB protocol, and differential signals of a “strong” magnitude are used to encode the standard “EOP” (End of Packet) USB state. In a further embodiment of the present invention, a sync signal is inserted into the data stream in order to reconcile the timing features of the standard USB protocol with the transmission delays which can be expected over long cable lengths.

### RELATED APPLICATION

The present application claims priority under 35 U.S.C. §119(e) from provisional application No. 60/210,577, filed Jun. 9, 2000.

### FIELD OF THE INVENTION

The present invention is directed generally to systems and methods for communications between computers and devices, and more particularly to a system and method for extending the distance over which signals implementing the Universal Serial Bus (“USB”) protocol may be transmitted.

### BACKGROUND OF THE INVENTION

Recently the USB interface has gained popularity as a user friendly way to connect add-on devices to a personal computer. The standard USB interface is intend to drive a maximum of approximately 15 feet (5 meters) of cable consisting of four wires: two for power and ground, and the other two for differential signaling, D+ and D−. Fully rated USB cables are shielded and provide a data rate of 12 Mbps over the 15-foot length. Low-speed cables are unshielded, but are limited to a maximum length of about 9 feet (3 meters) between connections. Additional details about the USB interface are readily available, and can be found on the Internet for example at http://www.usb.org/developers/download.html.

However, the USB signal, which is transmitted over these cables, is not a true differential signal with TTL levels, and is not designed for long distance applications. For example, the USB protocol includes an End of Packet (“EOP”) state in which both the D+ and D− lines are in a “single-ended 0” state, e.g. below 0.8 V. This “single-ended 0” state causes problems for long distance runs of cable, in part, because the state can cause interference with other devices as well as be susceptible to interference from other devices.

It would therefore be desirable to have a USB like system which is capable of transmission over cable distances greater than the standard 5 meters, and in which susceptibility to interference and in which the generation of interference with other systems and devices is at acceptable levels.

### SUMMARY OF THE INVENTION

The above and other problems with existing USB systems are overcome by the present invention of a USB extension system which converts the standard USB signal into a low voltage differential signal and is installed between a USB hub or host and a USB device. By driving the interconnecting cable with a true differential signal, i.e. a balanced signal, the problems with interference are greatly reduced. In accordance with the present invention, the standard USB signals are encoded into differential form using differential signals of different magnitudes. In one embodiment, differential signals of a “weak” magnitude are used to encode the “J” and the “K” states of the standard USB protocol, and differential signals of a “strong” magnitude are used to encode the standard “EOP” (End of Packet) USB state.

One embodiment of the USB extension system of the present invention has been found to be capable of driving up to 200 feet or more with twisted cable (two wire) without any software modification. In a further embodiment of the present invention, a sync signal (or signals) is inserted into the data stream in order to reconcile the timing features of the standard USB protocol with the transmission delays which can be expected over long cable lengths.

### BRIEF DESCRIPTION OF THE DRAWINGS

FIG. 1 is an illustration of one example of a system employing the present invention;

FIG. 2A is a functional block diagram of the USB Host-side Extension circuitry of one embodiment of the present invention;

FIG. 2B is a functional block diagram of the USB Device-side Extension circuitry of one embodiment of the present invention;

FIG. 3 is a timing diagram showing an example of data transfer from the host to a device in accordance with one embodiment of the present invention;

FIG. 4 is a timing diagram showing an example of data transfer from a device to the host in accordance with one embodiment of the present invention;

FIG. 5 is a state diagram illustrating the programming for the complex programmable logic device in the USB Host-side and USB Device-side Extensions of FIGS. 2A and 2B;

FIG. 6 is a timing diagram which illustrates the insertion of a SYNC signal in the data stream at the USB Host-side Extension in accordance to an embodiment of the present invention;

FIG. 7 is a timing diagram which illustrates the insertion of a SYNC signal in the data stream at the USB Device-side Extension in accordance to an embodiment of the present invention.

### DETAILED DESCRIPTION OF THE PREFERRED EMBODIMENTS

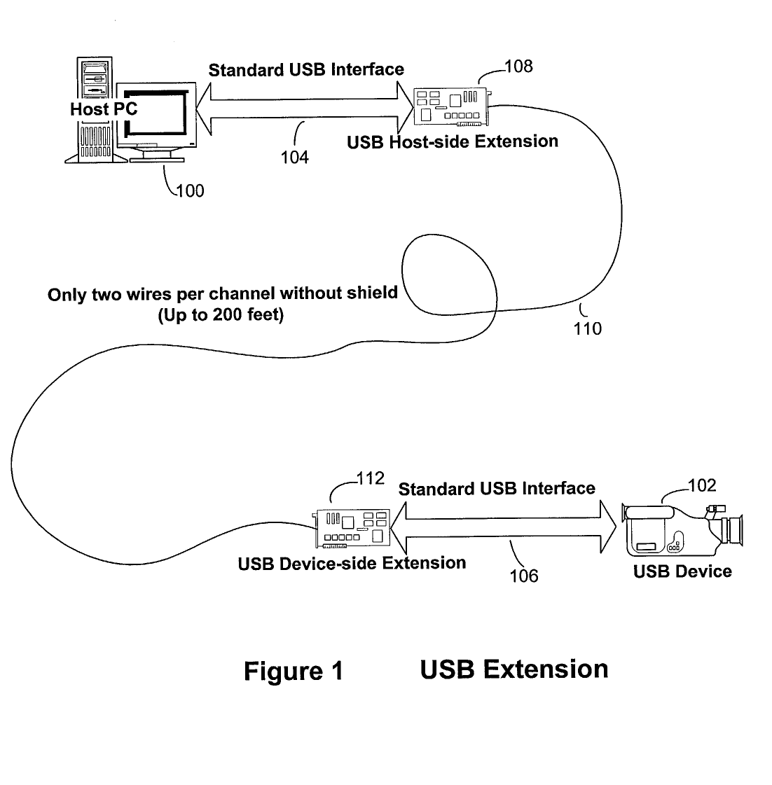

Referring now to FIG. 1, a host PC 100 is shown connected to a USB Device 102, for example a digital video camera, through what the USB Host PC 100 and USB Device 102 see as standard USB interfaces 104 and 106. However, interposed between the standard USB interfaces 104 and 106 is a USB Host-side Extension 108, up to 200 feet of unshielded twisted pair wire 110, and a USB Device-side Extension 112, in accordance with the present invention. The present invention permits a USB host and a USB device to communicate with one another using the standard USB protocol, but over a distance which is well over twenty (20) times the maximum allowed standard USB distance using unshielded wire.

The USB Host-side Extension 108 converts the USB signals received from Standard USB Port 104 into a true differential signal and drives cable 110 with that signal. USB Host-side Extension 108 also receives the differential signals from USB Device-side Extension 112 via cable 110, converts the signals into the standard USB format, and provides those coverted signals to the Standard USB Port 104.

Table 1 illustrates the conversion of the standard USB signals performed by the USB Host-side Extension 108 and the USB Device-side Extension 112, in accordance with the present invention:

TABLE 1

| | | USB BASIC STATES | | |
|---|---|---|---|---|
| | | | | EOP |
| | | J | K | (end of packet) |
| Standard | D+ | 1 | 0 | 0 |
| USB Signals | D− | 0 | 1 | 0 |
| (to/from USB | | | | |
| Host or | | | | |
| Device) | | | | |
| USB to | Data+ | Weak 1 | Weak 0 | Strong 1 |
| Differential | | (transfer 1) | (transfer 1) | (transfer 2) |
| Encoding | Data− | Weak 0 | Weak 1 | Strong 0 |
| (to/from | | (transfer 1) | (transfer 1) | (transfer 2) |
| cable) | | | | |

As used in Table 1, for the Standard USB Signals, a “1” on the D+ line and a “0” on the D− line represents a differential voltage level of about >2.5 V. On the other hand, a “0” on the D+ line and a “1” on the D− line represents a voltage difference of <−2.5 V. Thus, in the standard USB “J” state, the voltage difference between the D+ line and the D− line will be about >2.5 V. In turn, for the standard USB “K” state, the signal applied to the D+ line will be a “0”, while the signal applied to the D− line will be a “1,” for a voltage difference of about <−2.5 V. Note that the standard USB “EOP” state is represented by a “0” on the D+ line and a “0” on the D− line. This non-differential signal state is one which contributes to the constraints imposed on the maximum cable length in the standard USB configuration.

In contrast, the present invention provides a differential encoding to represent the “J” state in which a “weak 1” is applied to the Data+ line, and a “weak 0” is applied to the Data− line. A “K” state is represented by a “weak 0” on the Data+ line and a “weak 1” on the Data− line. In the embodiment of the present invention represented by Table 1, a “weak 1” on the D+ line and a “weak 0” on the D− line results in a differential voltage of about 0.8 V. Another difference in the present invention is that the “EOP” state is represented by a “strong 1” on the Data+ line, and a “strong 0” on the Data− line ((D+)−(D−)=1.4 V). In this manner, the Data+ and Data− lines are not both at the same voltage for any of the states to be represented. Therefore, cable 110 can be driven with a true differential or balanced signal for all states of the standard USB protocol that need to be transmitted between USB host and USB device.

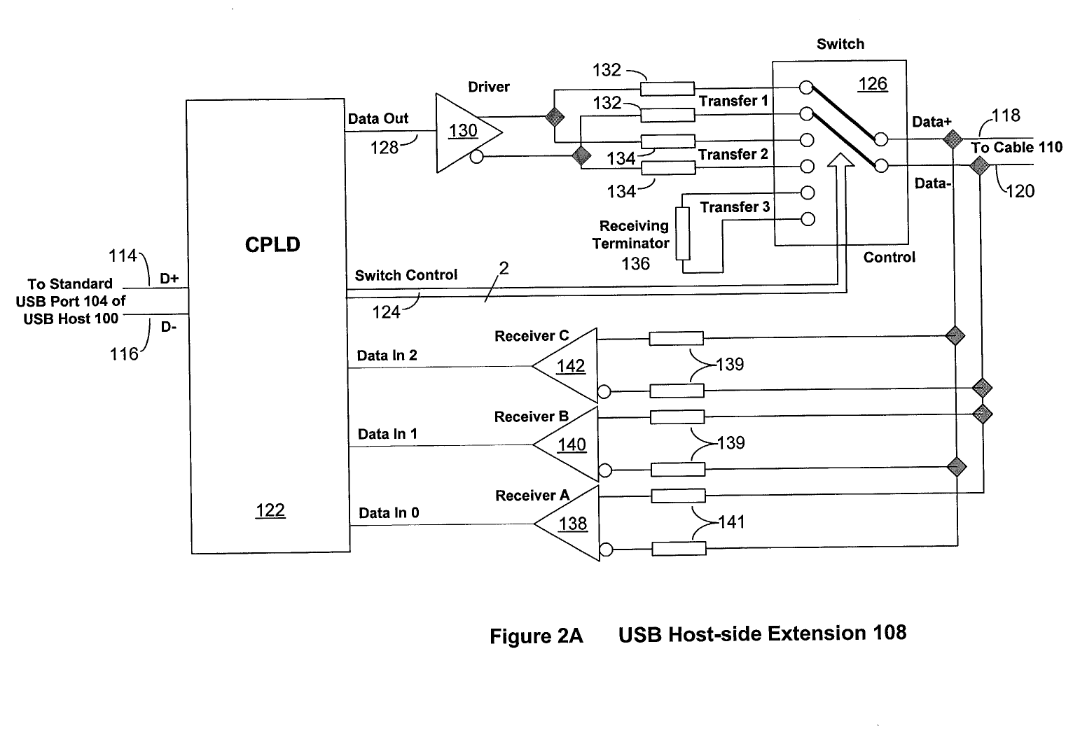

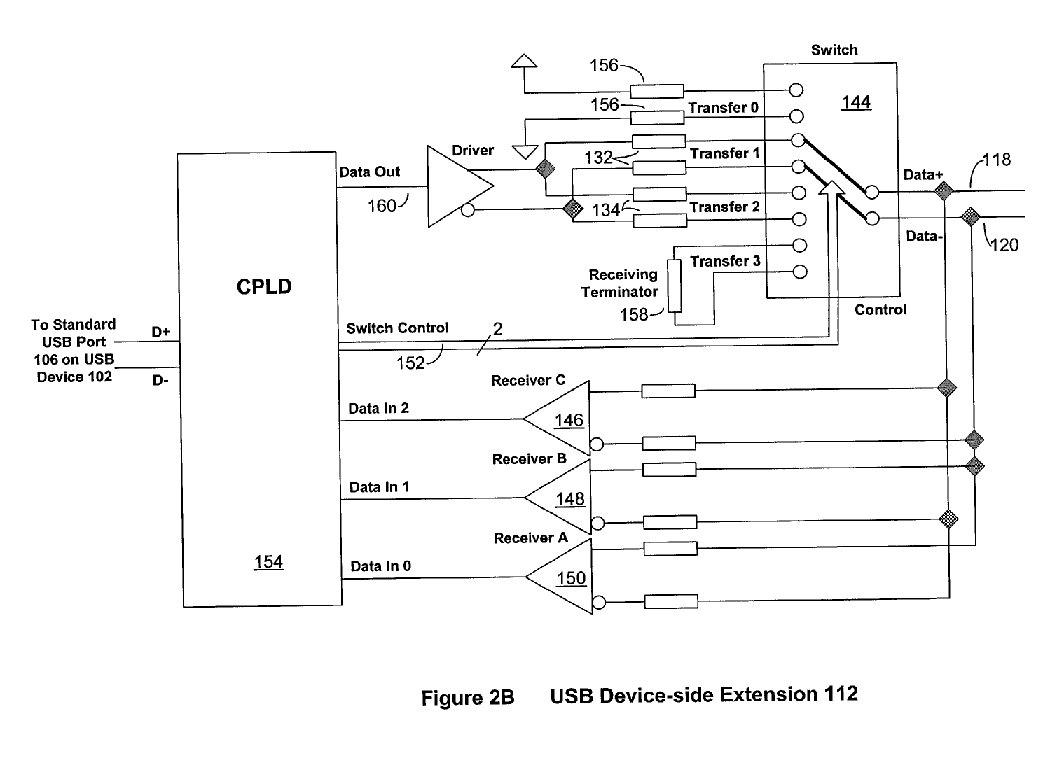

As will be explained in further detail in connection with FIG. 2A, the “transfer 1” and “transfer 2” states enclosed in parentheses in Table 1 represent switch settings used to encode the USB standard signal into the differential signal formats of the present invention. Thus the “transfer 1” state represents a switch setting which causes the signals being applied to the Data+ and Data− lines to have a “weak” signal level. The “transfer 2 ” state represents a switch setting which causes the signals being applied to the Data+ and Data− lines to have a “strong” signal level. This relationship will be explained in greater detail in connection with FIGS. 2A and 2B.

On the USB Device end of cable 110, the USB Device-side Extension 112 converts the USB signals received from the USB Device 102 on Standard USB Port 106 into a true differential signal and drives cable 110 with that signal. USB Device-side Extension 112 also receives the differential signals from USB Host-side Extension 108 via cable 110, converts the signals into the standard USB format, and provides those converted signals to the Standard USB Port 106 to which USB Device 102 is connected.

Table 2 illustrates the manner in which the USB differential encoding is handled between the USB Host-side Extension 108 and the USB Device-side Extension 112,in one embodiment of the present invention:

TABLE 2

| | | USB BASIC STATES | | |
|---|---|---|---|---|
| | | | | EOP |
| | | J | K | (end of packet) |
| UBS to | Data+ | Weak 1 | Weak 0 | Strong 1 |
| Differential | | (transfer 1) | (transfer 1) | (transfer 2) |
| Encoding | Data− | Weak 0 | Weak 1 | Strong 0 |
| (to/from | | (transfer 1) | (transfer 1) | (transfer 2) |
| cable) | | | | |
| Internal | Data In | 5 | 3 | 4 |
| Translation | [2,1,0] | | | |
| Code | | | | |
| Standard | D+ | 1 | 0 | 0 |
| USB Signals | D− | 0 | 1 | 0 |
| (to/from USB | | | | |
| Host or | | | | |
| Device) | | | | |

As illustrated in Table 2, an internal translation code is employed to identify the “J,” “K,” and “EOP” states. As will be explained in connection with FIGS. 2A and 2B, within the Host-side and the Device-side Extensions 108 and 112, a three-bit word is used to indicate the values shown for the Internal Translation Code in Table 2. Thus, the value “5” for the “J” state is represented by the three-bit binary word [101], the value “3” for the “K” state is represented by the three-bit binary word [011], and the value “4” is represented by the three-bit binary word [100].

Referring now to FIGS. 2A and 2B, functional block diagrams are provided for the circuitry of the Host-side and Device-side USB extensions 108 and 112, respectively, for one embodiment of the present invention. The operation of the circuitry in the Host-side and Device-side USB extensions 108 and 112 are very similar. One difference, as will be explained in connection with FIG. 2B, is that the USB Device-side Extension 112 can provide a “weakly terminated” state to cable 110.

The flow of signals from standard USB Port 104 through USB Host-side Extension 108 to cable 110 will now be described. In FIG. 2A, CPLD 122 is a complex programmable logic device, which decodes the USB signal incoming on standard USB Port 104 from USB Host 100 and generates a set of differential signals with different voltage levels and signal strengths, by external components. While a complex programmable logic device is shown, it is to be understood that other devices such as field programmable gate arrays or other logic arrays can be used to implement the functions performed by the CPLD 122. CPLD 122 can be model number 95144XL manufactured by XILINX of San Jose, Calif.

When signals are received from USB Host 100 through standard USB Port 104 on the D+ wire 114 and the D− wire 116, the CPLD 122 identifies the USB signal state being received. CPLD 122 then uses switch control line 124 to control the position of switch 126, and provides a data value on data out line 128 to driver 130. Driver 130 provides differential output signals, which are applied through series-connected impedances 132, and 134 to wires 118 and 120 of cable 110 by way of switch 126. Driver 130 can be a differential line driver model number 75ALS193, manufactured by Texas Instruments of Dallas, Tex.

The series-connected impedances 132 and 134 in the output of driver 130 can be resistors. These impedances operate in conjunction with a load or receiving terminator 158 in the USB Device-side Extension 112 at the other end of cable 110, FIG. 2B. The load or terminating resistor 158 is connected as a load across the wires of cable 110 when the USB Device-side Extension 112 is in a receiving mode. As will be appreciated by one skilled in the art, the magnitude of impedances 132 and 134 operate with the load 158 as a divider, and will determine the magnitude of the signals applied to cable 110. This is how the “weak” and “strong” signal magnitudes are set in the embodiment of FIGS. 2A and 2B for the Data+ and Data− states in Table 1. In one embodiment of the present invention, impedances 132 can be 100 ohm resistors, and impedances 134 can be 10 ohm resistors.

As an example, when CPLD 122 detects a “J” state in the incoming USB signal on standard USB Port 104, it will cause switch 126 to be in the “transfer 1 ” state shown in FIG. 2A. In this state, impedances 132 are connected in series between driver 130 and cable 110. CPLD 122 will also provide a logic “1” on data out line 128 which will cause the non-inverting output of driver 130 to be the more positive output compared to the inverting output. On the other hand, when CPLD 122 detects an “EOP” state on standard USB Port 104, it will assert a signal on switch control 124 which will cause switch 126 to be in the “transfer 2” state, and will assert a logic “1” on the data out line 128. This causes impedances 134 to be connected in series between driver 130 and cable 110 and the non-inverting output of driver 130 to go high, and the inverting output to go low. Assuming that cable 110 is terminated at the USB Device-side Extension 112 with a load of about 100 ohms, it can be seen that the magnitude of the differential voltage generated across the load will be substantially greater in the “transfer 2” position, which employs 10 ohm resistors, versus the “transfer 1 ” position which employs 100 ohm resistors; namely, approximately 0.33*V_{applied} for the “transfer 1” state, versus approximately 0.833*V_{applied} for the “transfer 2” state, where V_{applied} represents the voltage difference between the differential outputs of driver 130.

Focusing now on the flow of signals from cable 110 through USB Host-side Extension 108 to standard USB Port 104, it can be seen in FIG. 2A that Receivers A (138), B (140), and C (142), are connected between cable 110 and inputs to CPLD 122, and that switch 126 has a “transfer 3” state(receive mode). These elements are used for the receipt and processing of signals received from cable 110 such as when USB Host-side Extension 108 is receiving data from USB Device-side Extension 112. In such a state, CPLD 122 uses switch control 124 to command switch 126 into position “transfer 3(receive mode).” This places receiving terminator 136 across wires 118 and 120 of cable 110 as a load. Receiving terminator 136 can be a 100 ohm resistor, for example.

In turn, Receivers A, B, and C are coupled to cable 110 and operate as comparators to detect the different differential signal states that may appear on cable 110. In FIG. 2A it can be seen that the non-inverting input of Receiver C (142) is coupled to Data+ wire 118 of cable 110, and that the inverting input is coupled to Data− wire 120. On the other hand, it is the non-inverting input of Receiver B (140) which is coupled to Data− wire 120 and the inverting input of Receiver B (140) which is coupled to Data+ wire 118. For Receiver A (138), the non-inverting input is coupled to Data− wire 120, while the inverting input is coupled to Data+ wire 118. The elements 139 and 141, which couple the inputs of Receivers A, B and C to wires 118 and 120 of cable 110 are typically impedances and can be resistors. In one embodiment of the present invention, elements 139 are 68 ohm resistors connected in series in the inputs for Receiver B (140) and Receiver C (142), while elements 141 are 330 ohm resistors connected in series in the inputs for Receiver A (138). Receivers A, B and C can be differential line receiver model number 75ALS194 manufactured by Texas Instruments of Dallas, Tex.

Table 3 illustrates, for one embodiment of the present invention, the relationship between the USB Basic States which are encoded and transmitted along cable 110 the signal states for those encoded states which are applied to the Data+ and Data− wires, the differential voltages which result at the receiving end of cable 110 the outputs of Receivers A (138), B (140) and C (142) upon detection of those encoded states at the receiving end, and the corresponding HEX value of the outputs of Receivers A (138), B (140) and C (142) for those detected states:

TABLE 3

| USB | | | | Data | Data | Data | |
|---|---|---|---|---|---|---|---|
| Basic | | | (Data +) − | In | In | In | |
| State | Data+ | Data− | (Data −) | 2 | 1 | 0 | Code |
| J | Weak 1 | Weak 0 | +0.8 V | 1 | 0 | 1 | 5 |
| K | Weak 0 | Weak 1 | −0.8 V | 0 | 1 | 1 | 3 |
| EOP | Strong 1 | Strong 0 | +1.4 V | 1 | 0 | 0 | 4 |

Receiver A (138) is configured to detect when either the Data− wire 120 or the Data+ wire 118 is more positive than the other by only the “weak” logic 1 signal condition; or, from another perspective, to indicate by outputting a logic “0” that the Data+ wire 118 is more positive than Data− wire 120 by a “strong” logic 1 condition. Receiver B (140) is configured to detect whether the Data− wire 120 is more positive than Data+ wire 118 by at least the “weak” logic 0 signal condition. Receiver C (142) detects whether the Data+ wire 118 is more positive than Data− wire 120 by at least the “weak” logic 1 signal condition.

The output of Receiver A (138) is supplied to the Data In 0 input of CPLD 122, the output of Receiver B (140) is supplied to the Data In 1 input, and the output of Receiver C 142 is supplied to the Data In 2 input of CPLD 122. In turn, CPLD 122 decodes these inputs in accordance with the protocol illustrated in Tables 2 and 3 above, into the standard formats for USB signals, and supplies these decoded signal on standard USB Port 104.

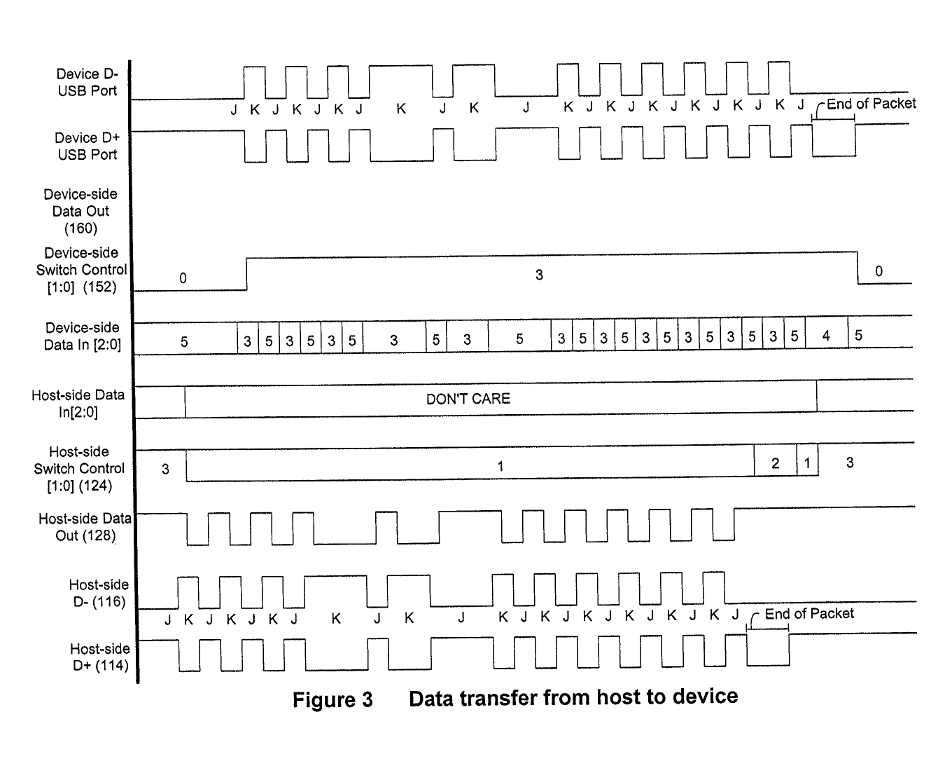

FIG. 3 is a timing diagram illustrating logic states during a data transfer from USB Host 100 to USB Device 102 using the USB Host-side Extension 108, USB Device-side Extension 112 and interconnecting cable 110 in accordance with the present invention. The signal activity can be seen as starting at that bottom of the figure and ending at the top.

In FIG. 3 the bottom five traces illustrate signals at USB Host-side Extension 108. The bottom two traces illustrate the D+ and D− signals at standard USB Port 104 from USB Host 100. These are the signals received by CPLD 122 on wires 114 and 116. The “Host-side Data Out” trace, immediately above, illustrates the signals supplied by CPLD 122 on Data Out line 128 to Driver 130, FIG. 2A. Above that trace is the “Host-side Switch Control” signal on supplied by CLPD 122 on 124 to switch 126, FIG. 2A. Note that a “Don't Care” signal shown for the “Host-side Data In” trace, shown immediately above the “Host-side Switch Control” signal trace, because in the example of FIG. 3 the Host-side Extension 108 is transmitting data from USB Host 100 to USB Device 102, and therefore the outputs of Receivers A, B and C are “Don't Cares.”

The left most portions of these bottom five traces illustrates the point in time when USB Host-side Extension 108 is waiting for data and then receives a “J” state from USB Host 100. In this state, the Host-side switch control signal on line 124 is in a “3” state; i.e. where switch 126 is in the “transfer 3” (receive mode) position so that receiving terminator 136 is connected across wires 118 and 120, so that data can be received from the USB Device 102. However, once CPLD 122 detects the “J” state at standard USB Port 104, CPLD 122 issues a “1” state on Switch Control line 124, as shown in the “Host-side Switch Control” trace. Also, at that time, CPLD 122 issues a data state on data out line 128 corresponding to the received “J” state, as shown in the “Host-side Data Out” trace. Note that as “J” and “K” states are received, the switch control line state remains at “1,” since for these states the USB Host-side Extension 108 issues a “weak 1” or “weak 0.” On the other hand, as shown on the right hand side of FIG. 3, when an End of Packet state is received from USB Host 100, CPLD 122 issues a switch control state “2” on switch control line 124. This causes switch 126 to assume a “transfer 2” position so that a “strong 1” and a “strong 0” can be transmitted. Following the EOP state, the data from USB Host 100 is a “J” state followed by an idle state, and thus the switch control states in the “Host-side Switch Control” trace change from a “1” state (transfer 1—“weak”) to a “3” state (transfer 3—wait for data) (receive mode).

The top five traces in FIG. 3 illustrate signals in the USB Device-side Extension 112, FIG. 2B for the illustrated example of data transfer from USB Host 100 to USB Device 102. The “Device-side Data In” trace illustrates the hex equivalent of the outputs of Receiver C (146), Receiver B (148) and Receiver A (150) in response to the signals being received on cable 110 from USB Host-side Extension 108. See Table 3, above. The first state shown at the left-hand side of the trace is a “5” which represents a “J” state. Thereafter states “3” and “5” are shown to have been detected, which represent “K” and “J” states. It is to be noted, that during this time, “Device-side Control Switch” trace initially shows a “0” state, and then a “3” state. The “0” state corresponds to the “transfer 0” state of switch 144, FIG. 2B. In FIG. 3, the “Device-side Switch Control” trace represents the switch control signals provided on switch control line 152 from CPLD 154 to switch 144, FIG. 2B. This “transfer 0” state in the USB Device-side Extension 112 is a “weakly” terminated state, and is meant to signal a “device connected” condition. As can be seen from FIG. 2B, in the “transfer 0” state switch 144 connects wires 118 and 120 to loads 156 (which can be pull up and pull down resistors).

Comparing the left most portions of the “Device-side switch control” and the “Device-side Data In” traces, it can be seen that initially, the “Device-side Switch Control” trace shows a “0” state indicating a weakly terminated state for USB Device-side Extension 112, and that “Device-side Data In” trace shows a “5” state, which according to Tables 2 and 3, hereinabove, represents the detection of a “J” state by Receivers A (150), B (148) and C (146) of USB Device-side Extension 112. It is to be noted that shortly after the time Receivers A (150), B (148) and C (146) detect the following “K” state, the CPLD 154 has issued a “transfer 3” state (receive mode) on switch control line 115, thus placing the receiving terminator load 158 across wires 118 and 120. It is to be understood that Receivers A (150), B (148) and C (146) can detect the signal states on cable 110 even when switch 144 is in the “transfer 0” (weakly terminated) state, and that is why the initial “J” and “K” states in the “Device-side Data In” trace of FIG. 3 are detected during the “transfer 0” state in the “Device-side Switch Control” trace. In accordance with the standard USB protocol, a packet of data begins with a “Start of Packet” sequence which is followed by the actual data. It is this “Start of Packet” sequence that is being detected while the USB Device-side Extension 112 is in the “transfer 0” state. Thus, by the time the actual data is being received by the USB Device-side Extension 112, the switch 144 will be in the “transfer 3” state (receive mode). Use of the “transfer 3” state (receive mode) for subsequent operation, once activity on cable 110 is detect, provides for better noise immunity and lower error rates.

Continuing with FIG. 3, the “Device-side Data Out” trace corresponds to the signals on the data out line 160 from CPLD 154, FIG. 2B. The “Device-side Data Out” trace is blank under the conditions illustrated in FIG. 3 because data is not being transmitted by the USB Device-side Extension 112.

Finally, in FIG. 3, the top two traces “Device D−” and “Device D+” illustrate the data signals provided by the CPLD 154 to the USB Device 102 on USB Port 106. As can be seen from the traces, the USB Device 102 is provided with the standard USB “J” and “K” signals. Also to be noted at the end of the traces is that, as required by the USB standard, the EOP signal provided to USB Device 102 is the standard D+ and D−, both at a “0V” level.

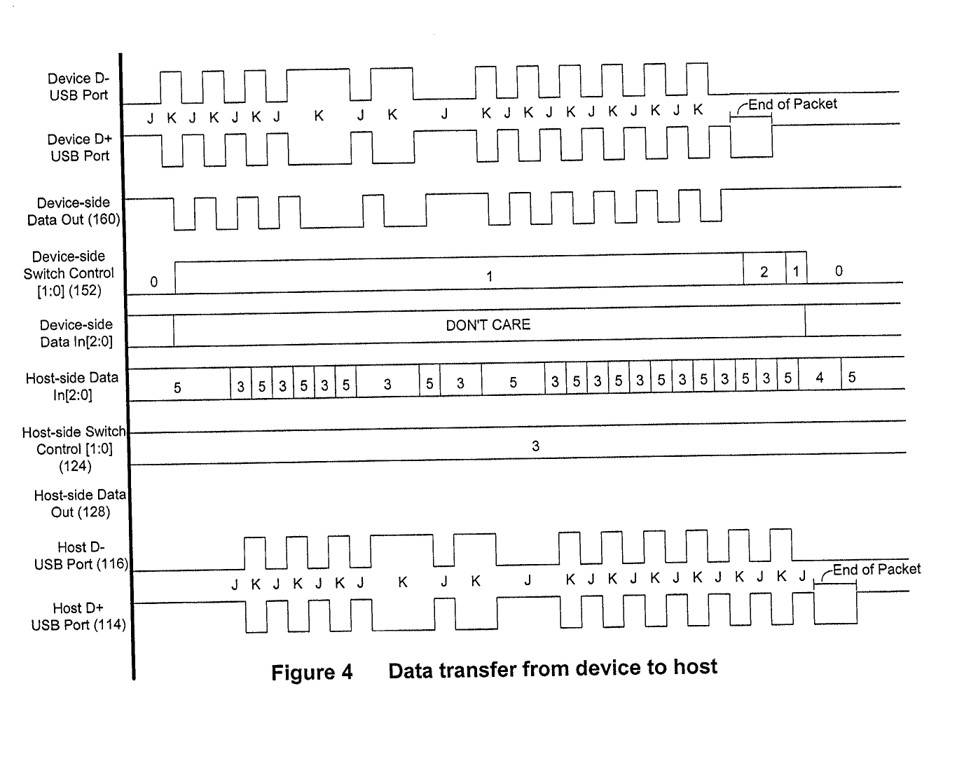

Referring now to FIG. 4, data transfer from the USB Device 102 to USB Host 100 will now be described in accordance with one embodiment of the present invention. The traces shown in FIG. 4 represent the same signal points as in FIG. 3, however, the data flow is now from the USB Device 102 to the USB Host 100. Thus, the signal activity begins with the top trace and ends at the bottom trace.

Beginning with the top two traces, “Device D−” and “Device D+” illustrate the signals being applied by the USB Device 102 to the D− and D+ lines of CPLD 154 in the USB Device-side Extension 112, FIG. 2B. The signals shown are a series of “J” and “K” states, and eventually end with an End of Packet state. The “Device-side Switch Control” trace shows that the USB Device-side Extension 112 is initially in a “transfer 0” state in which wires 118 and 120 of cable 110, FIG. 2B, are weakly terminated. It can be seen that shortly after the USB Device 102 applies the first “J” and “K” states (representing a Start of Packet) to the Device D− and Device D+ lines, CPLD 154 issues a “transfer 1” state on switch control line 152 (Device-Side Switch Control trace) and a logic 1 on Data Out line 160 (Device-side Data Out trace). Recall that the “transfer 1” state of switch 144 causes “weak 1” and “weak 0” logic states to be applied to cable 110. It is also to be noted, that toward the end of the transmission sequence illustrated in FIG. 4, and in connection with the End of Packet signal from USB Device 102, the CLPD 154 issues a “transfer 2” command on switch control line 152 to place switch 144 into the position in which “strong 1” and “strong 0” signals are applied to cable 110. This is followed by a “transfer 1” command for a single bit period, and then a “transfer 0” command.

It is to be noted that the “Device-side Data In” trace is a “Don't Care” in FIG. 4 because in the illustrated example, data is being transmitted by the USB Device-side Extension 112, therefore any outputs from Receivers A, B and C, representing incoming data on cable 110, are “Don't Cares.”

Referring now to the bottom five traces of FIG. 4, which represent signals on the USB Host-side Extension 108, it can be seen from the “Host-side Switch Control” trace, that switch 126 initially starts and remains in a “transfer 3” (receive mode) (see FIG. 2A wherein receiving terminator 136 is connected across wires 118 and 120 of cable 110). In the “Host-side Data In” trace the “J” state is represented by the “5” code and the “K” state is represented by the “3” code. It is also to be noted that toward the end of the transmission sequence, a “4” (End of Packet) state is shown detected in the “Host-side Data In” trace. However, even following the detection of this End of Packet state, the CPLD 122 continues to keep switch 126 in a “transfer 3” state (receive mode) as indicated by the continued “transfer 3” state (receive mode) in the “Host-side Switch Control” trace.

In FIG. 4, the “Host-side Data Out” trace is blank because no data is being transmitted by USB Host-side Extension 108 in the example being illustrated.

Finally, it can be seen from the bottom two traces of FIG. 4, that CPLD 122 issues the received “J,” “K” and “EOP” signals to the Host-side USB Port 104 in the standard USB signal protocol.

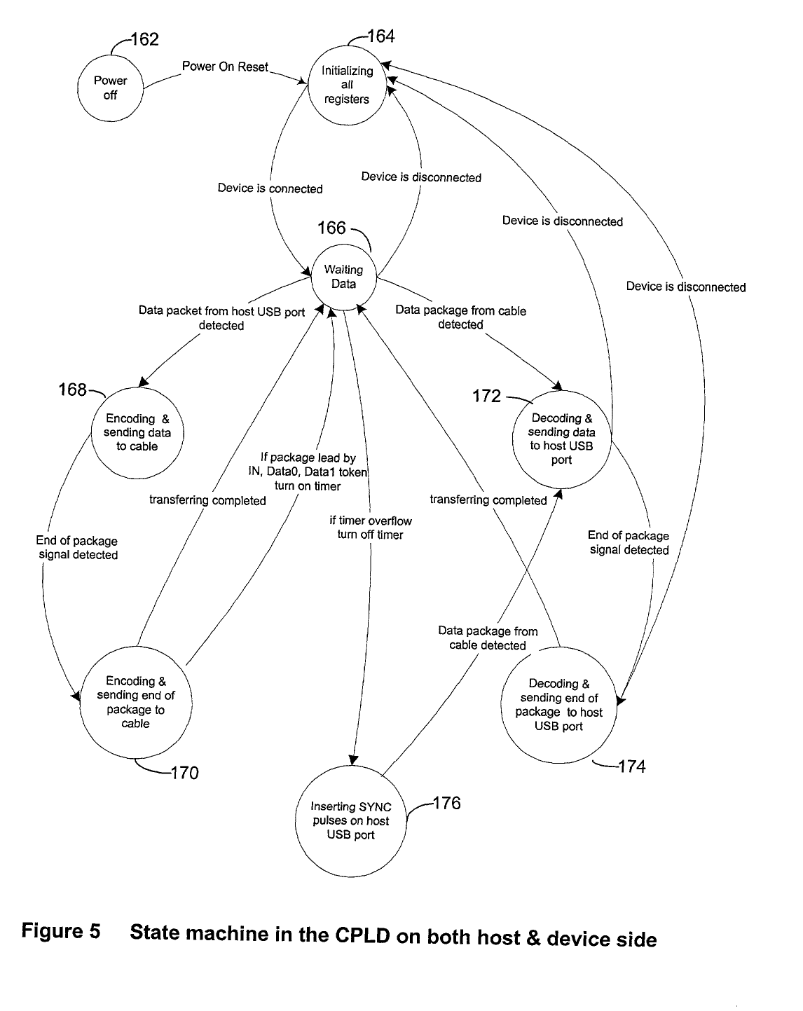

FIG. 5 is a state diagram illustrating the primary operational states of the present invention. Upon application of power to the USB Host-side Extension 108 and the USB Device-side Extension 112 the devices leave the power off state 162 and execute a power on reset operation in which all registers are initialized in state 164. Following the completion of register initializing state 164, the system is in a “device is connected” state, and waits for data in state 166. In state 168, the USB Host-side Extension 108 waits for data from the USB Host 100 and from the cable 110, and USB Device-side Extension 112 waits for data from USB Device 102 and from the cable 110. In order to simplify the explanation, reference hereafter will be made to the USB Host-side Extension 108, it being understood that the explanation is applicable to the USB Device-side Extension 112 as well.

If in state 166 a data packet from the host USB Port 104 is detected, state 168 is entered in which the detected data are encoded in accordance with the present invention and transmitted over cable 110. When an End of Packet (“EOP”) signal is detected by CPLD, state 170 is entered in which an EOP signal is encoded and sent out over cable 110. Recall that this EOP signal is encoded in accordance with Table 1 hereinabove. Following the EOP encoding and transmission, the transmission is complete and the system returns to state 166 in which it waits for data.

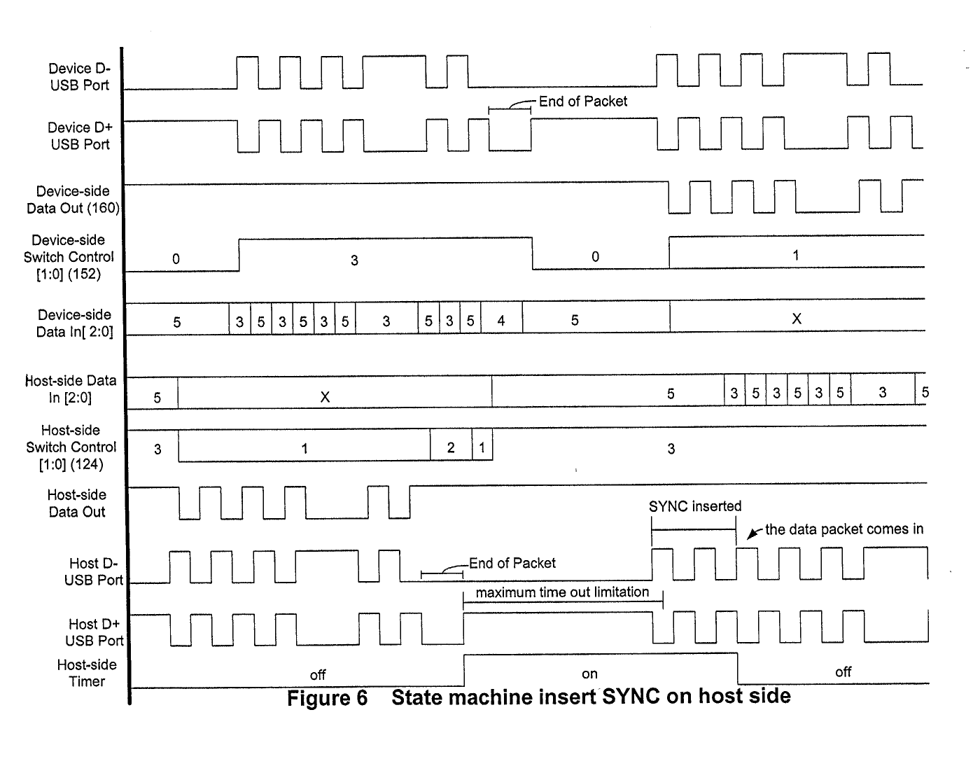

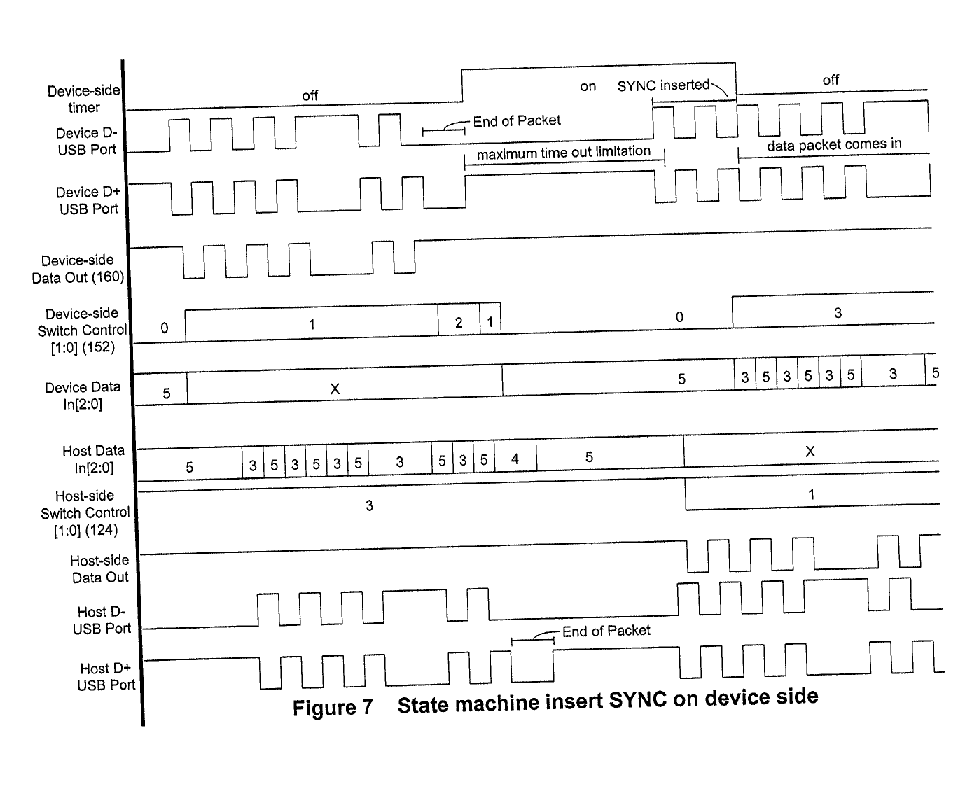

It is to be noted that another operation, which may occur after state 170 is completed, involves starting a timer if certain types of packets have been transmitted over cable 110. The packets of interest are those in connection with which a response is expected back over cable 110 in a prescribed amount of time. As will be described in greater detail herein, because the present invention is capable of communication over significantly greater lengths of cable than the standard USB configuration, in accordance with the present synchronization pulses can be inserted into the data stream to compensate for transmission delays over the longer lengths of cable which may cause the USB system to otherwise time-out. This aspect of the present invention will be discussed in greater detail in connection with FIGS. 6 and 7.

Returning now to FIG. 5, when data on the cable 110 is detected when the system is in state 166 the data is decoded into a standard USB format and then sent by the CPLD 122 to the USB host port 104 in state 172. Then in state 174, upon detection of an EOP signal on cable 110 the EOP signal is decoded into standard USB format and sent by CPLD 122 to USB host port 104 in state 174. Thereafter, the system returns to state 166. It is to be noted in states 166, 172 and 174, if the USB Device 102 is determined to have been disconnected, the system will return to state 164 in which all registers are initialized.

Referring now to FIGS. 5, 6 and 7, the insertion of a sync signal into the data stream in accordance with the present invention will now be described in greater detail, and will be better understood upon consideration of the following background information. According to the standard USB protocol, the maximum bus turnaround time to prevent transmitter side time-out is 16 bits; e.g., 1280 nsec for a full speed USB device. This includes a device maximum response time of 6.5 bits; e.g., 520 nsec for a full speed USB device. The embodiment of present invention described above is capable of driving up to 200 feet or more of CAT5 twisted pair cable. The round trip signal delay for 200 feet of CAT5 twisted pair cable, assuming a delay of 1.5 nsec per foot, is about 1.5×200×2=680 nsec. Further more, the logic delay and driver delay in the USB Host-side Extension 108 and the USB Device-side Extension 112 can be on the order of 320 nsec. When these delays are accumulated, it can be seen that the standard maximum USB turnaround time of 1280 nsec will be exceeded: T(response)+T(logic delay & driver)+T(cable delay)=520+320+680=1520>1280 nsec.

In order to overcome the possibility of an unintended time-out, a sync signal is inserted into the data stream when needed in accordance with the present invention. As indicated in FIG. 5, as an action following completion of state 170, the present invention will start a timer when certain kinds of packets are being sent: for example, IN, Data 0 and Data 1 packets. Generally, these are the packets for which the USB host expects a response within a time-out period. Typically, information about the type of data being sent is found in the Packet ID portion of the packet, which typically follows the standard USB sync signal, and which is prefixed to each packet. Table 4 lists examples of the kinds of data transmissions in connection with which the present invention will insert a “sync” signal.

TABLE 4

| | |
|---|---|
| TYPE | WHEN INSERTED |

HOST-SIDE TO DEVICE-SIDE TRANSMISSION

| | |
|---|---|
| Data0 | After data packet |
| Datal | After data packet |
| IN | After “In” token |

DEVICE-SIDE TO HOST-SIDE TRANSMISSION

| | |
|---|---|
| IN from host, followed by data from device | After data from device |

When the timer has been started and thereafter overflows, the present invention will begin sending sync pulses to the USB Host 100 on USB Port 104, FIG. 5, state 176. These sync pulses, in effect, inform the USB Host 100 that information will be forthcoming and to hold the channel open. The system continues to send out sync pulses in state 176, up to a selected maximum number of sync pulses, until the expected data packet is received on cable 110 or the maximum number of sync pulses has been sent out.

In one embodiment of the present invention, up to eight (8) sync pulses are sent out. If no data packet is detected on cable 110 after the eighth sync pulse has been sent, the system treats the condition as a time-out. If a data packet has been detected on cable 110 within the eight (8) sync pulse period, state 172 is entered (FIG. 5) in order to decode and send the data to the host USB Port 104.

FIG. 6 illustrates the insertion of sync pulses by the USB Host-side Extension 108. Shown as the bottom trace of FIG. 6 is the “Host Timer” state, which illustrates the state of the timer within the USB Host 100 which sets the period after which the USB Host 100 will consider a time out to have occurred in connection with the connected device.

The “Host D+” and “Host−” traces are annotated to indicate the maximum time out limitation imposed by the USB protocol following the EOP in the data packet. It is to be noted that in the Host-side timer is turned on at the end of the EOP section of the data packet. It is also to be noted that at a point in time, for example one-half bit time, before the end of the maximum time out limitation, the system begins to apply sync pulses onto the Host-side D+ and D− lines of USB Port 104 in accordance with the present invention

In the example of FIG. 6, the “Device-side Data Out” trace shows that, after about two sync pulses are sent to the USB Host 100 on USB Port 104, the expected data is received from USB Device-side Extension 112 on cable 110. See the “Host-side Data In” trace and the transition from state “5” to state “3” which is aligned with the end of the sync pulse sequence. At this point the received data is decoded into standard USB format and sent out to USB Host 100 on USB Port 104. This causes the Host-side timer to be turned off, as can be seen in the right hand side of the “Host-side Timer” trace which is aligned with the end of the sync pulse sequence.

FIG. 7 illustrates the insertion of sync pulses by the USB Device-side Extension 112, in order to prevent the timer in the USB Device 112 from timing out. Thus, top trace “Device timer” illustrates the state of the timer within USB Device 112. The maximum time out limitation is shown as an annotation within the “Device-side D−” and “Device-side D+” traces. Also shown are the sync pulses which are inserted in the “Device-side D−” and “Device-side D+” signals to USB Device 102 on USB Port 106.

In the “Host-side D−” and “Host-side D+” traces at the bottom of FIG. 7, it can be seen that the data from USB Host 100 arrives at the USB Port 104 at a point where it reaches the USB Device 102 on the other end of cable 110 after the “maximum time out limitation” has been exceeded. However, since the system of the present invention has inserted a set of sync pulses in the data to the USB Device 102, the communications to the USB Device 102 have been kept open and ready for receipt of the data packet.

What is claimed is:

1. A USB extension system for enabling communications between a USB hub or host and a USB device over a communications path having a length which can substantially exceed a standard USB separation distance, the system comprising
a first interface coupleable between the USB hub or host and the communications path, and which is capable of converting standard USB signals received from the USB hub or host into differential form, and is capable of converting signals received in differential form from the communications path into standard USB signals; and
a second interface coupleable between the USB device and the communications path, and which is capable of converting a standard USB signal received from the USB device into differential form, and is capable of converting signals received in differential form from the communications path into standard USB signals.

2. The USB extension system of claim 1, wherein the communications path is unshielded twisted-pair wire.

3. The USB extension system of claim 1, wherein the signals of differential form include a first differential form having a first magnitude, and a second differential form having a second magnitude less than the first magnitude.

4. The USB extension system of claim 3, wherein J-state USB signals and K-state USB signals are converted by the first and second interfaces into the second differential form having the second magnitude, and End of Packet-state USB signals are converted by the first and second interfaces into the first differential form having the first magnitude.

5. The USB extension system of claim 1, wherein the second interface includes a timer which selectively inserts a synchronizing signal onto the communications path.

6. A USB extension system for enabling communications between a USB hub or host and a USB device, the system comprising
a communications path having a length substantially greater than a standard USB separation distance;
a host-side extension coupleable between the USB hub or host and the communications path, and which is capable of converting standard USB signals received from the USB hub or host into differential form, and is capable of converting signals received in differential form from the communications path into standard USB signals; and
a device-side extension coupleable between the USB device and the communications path, and which is capable of converting a standard USB signal received from the USB device into differential form, and is capable of converting signals received in differential form from the communications path into standard USB signals.

7. The USB extension system of claim 6, wherein the communications path is unshielded twisted-pair wire.

8. The USB extension system of claim 6, wherein the signals of differential form include a “strong” differential form having a first magnitude, and a “weak” differential form having a second magnitude less than the first magnitude.

9. The USB extension system of claim 8, wherein standard J-state and K-state USB signals are converted by the host-side and device-side extensions into the “weak” differential form having the second magnitude, and standard EOP-state USB signals are converted by the host-side and device-side extensions into the “strong” differential form having the first magnitude.

10. The USB extension system of claim 6, wherein the second interface includes a timer which selectively inserts a synchronizing signal onto the communications path.

11. An interface for use with a USB system having a host, comprising
a driver circuit responsive to standard USB signals received at a host-side port from the host, wherein the driver circuit drives a cable-side port with differential signals which have been converted into differential form from the standard USB signals; and
a receiver circuit responsive to signals in differential form received at the cable-side port, wherein the receiver circuit drives the host-side port with standard USB signals which have been converted into standard USB form from the signals in differential form received at the cable-side port.

12. An interface for use with a USB system having a USB device, comprising
a driver circuit responsive to standard USB signals received at a device-side port from the USB device, wherein the driver circuit drives a cable-side port with differential signals which have been converted into differential form from the standard USB signals; and
a receiver circuit responsive to signals in differential form received at the cable-side port, wherein the receiver circuit drives the driver-side port with standard USB signals which have been converted into standard USB form from the signals in differential form received at the cable-side port.

13. A USB extension system for enabling communications between a USB hub or host and a USB device over a communications path having a length which can substantially exceed a standard USB separation distance, the communications including packets of the type the transmission of which by the USB hub or host or USB device triggers a time-out period within which a response is expected, the system comprising
a first interface coupleable between the USB hub or host and the communications path, and which is capable of converting standard USB signals received from the USB hub or host for transmission over the communications path, and is capable of converting signals received from the communications path into standard USB signals, the first interface including a first timing sequencer responsive to receipt of the packets from the USB hub or host and which transmits to the USB hub or host hold-open signal for a predetermined period of time; and
a second interface coupleable between the USB device and the communications path, and which is capable of converting a standard USB signal received from the USB device for transmission over the communications path, and is capable of converting signals received from the communications path into standard USB signals, the second interface including a second timing sequencer responsive to receipt of the packets from the USB device and which transmits hold-open signals to the USB device for a predetermined period of time.

14. The USB extension system of claim 13, wherein the hold-open signals are sync pulses, and the first and second timing sequencers transmit sync pulses up to a predetermined number of sync pulses or receipt of the expected response, whichever occurs first.

15. The USB extension system of claim 13, wherein the first and second timing sequencers are state machines.

16. An interface for use between a USB system and a wire pair, comprising
a standard USB port;
a differential driver circuit responsive to standard USB signals received at the standard USB port;
a plurality of pairs of driver impedances, wherein each of the pairs of driver impedances has a different magnitude, and further wherein each driver impedance of each of the pairs of driver impedances is driven at one end by the differential driver circuit;
a receiving terminator impedance;
a switch having first and second output contacts capable of being coupled to the wire pair, and a plurality of pairs of input contacts, wherein each of the plurality of pairs of input contacts is coupled to a different one of the pairs of driver impedances or the receiving terminator impedance, and further wherein the switch is controllable to couple a selected one of the pairs of input contacts to the first and second output contacts;
a plurality of comparators, each coupled to the first and second output contacts and having an output indicative of signal levels on the first and second output contacts within a different predetermined magnitude range; and
translation circuitry responsive to the standard USB signals for controlling the switch according to states of the standard USB signals, and coupled to receive the outputs of the plurality of comparators for converting the detected signal levels into standard USB signal states.

17. The interface of claim 16 wherein the translation circuitry is a programmed complex programmable logic device.

18. The interface of claim 16 further including a further pair of impedances each of which is coupled to a reference potential at one end and to a further pair of input contacts of the switch at another end.

19. The interface of claim 16 wherein a first one of the plurality of comparators is capable of detecting when the first output contact has a difference in potential from the second output contact which is no greater than a first magnitude; a second one of the plurality of comparators is capable of detecting when the second output contact is more positive than the first output contact by at least the second magnitude; and a third one of the plurality of comparators is capable of detecting when the first output contact is more positive than the second output contact by at least the first magnitude.

20. A USB extension system adapted to permit communications between a USB hub or host and a USB device over a communications path having a length which can substantially exceed a standard USB separation distance, the system comprising
a first interface adapted to be coupled between the USB hub or host and the communications path, and which is capable of converting standard USB signals into a multilevel differential form, and is capable of converting signals received in the multilevel differential form into standard USB signals; and
a second interface adapted to be coupled between the USB device and the communications path, and which is capable of converting a standard USB signal into the multilevel differential form, and is capable of converting signals received in the multilevel differential form into standard USB signals.
